(19) United States
(12) Patent Application Publication
(10) Pub. No.: US 2025/0201035 A1
(43) Pub. Date: Jun. 19, 2025

(54) METHOD OF PREDICTING SOUND QUALITY INDEX FOR ELECTRIC VEHICLE NOISE

(71) Applicants: HYUNDAI MOTOR COMPANY, SEOUL (KR); KIA CORPORATION, SEOUL (KR)

(72) Inventors: Dong-Chul Lee, Hwaseong-si (KR); Kyoung-Jin Noh, Hwaseong-si (KR); In-Soo Jung, Hwaseong-si (KR)

(73) Assignees: HYUNDAI MOTOR COMPANY, SEOUL (KR); KIA CORPORATION, SEOUL (KR)

(21) Appl. No.: 18/739,682

(22) Filed: Jun. 11, 2024

(30) Foreign Application Priority Data
Dec. 13, 2023 (KR) 10-2023-0181103

(51) Int. Cl. G07C 5/02; G06N 20/00

(52) U.S. Cl. CPC G07C 5/02; G06N 20/00

(57) ABSTRACT

A method of predicting a sound quality index of an electric vehicle, the method includes acquiring vehicle interior noise and vehicle data of the electric vehicle, evaluating, by a jury test, the sound quality index for a high-frequency whine noise component of the vehicle interior noise, extracting features to be used as predictors for modeling the sound quality index, learning a sound quality index model from the features to be used as predictors, and completing the sound quality index model, wherein the correlation of the sound quality index model with the sound quality index evaluation is 0.9 or more.

### CROSS REFERENCE TO RELATED APPLICATIONS

This application claims priority to Korean Patent Application No. 10-2023-0181103, filed on Dec. 13, 2023, which is incorporated herein by reference in its entirety

### BACKGROUND

### Field of the Disclosure

The present disclosure relates to a method of predicting a sound quality index capable of evaluating noise, vibration, harshness (NVH) performance for each noise and overall noise by separating high-frequency whine noise from interior noise data of an electric vehicle.

### Description of Related Art

Traditionally, for vehicles, especially electric vehicles, sound quality indexes have been evaluated using interior noise data, with developers comparing noise levels in key frequency bands to development target levels. This inevitably depends on the developer's analytical capabilities and experience, and has limitations on a qualitative assessment.

Recently, development goals have been established for electric vehicle parts, which are electrification systems, and development work is underway by applying a level comparison analysis method using a simple frequency filter.

In particular, attempts are being made to improve the accuracy of the prediction by separating the background noise source from the high-frequency whine noise source caused by a motor among the electric vehicle parts.

### SUMMARY

The present disclosure is intended to develop a sound quality index capable of performing quantitative noise, vibration, harshness (NHV) evaluation for high-frequency whine noise, background noise, and overall noise caused by a motor through noise separation for each noise source, using interior noise data, motor revolutions per minute (rpm) data, and speed data of an electric vehicle.

In an aspect, the present disclosure provides a method including: acquiring vehicle interior noise and vehicle data of an electric vehicle; evaluating, by a jury test, a sound quality index for a high-frequency whine noise component of the vehicle interior noise; extracting features to be used as predictors for modeling the sound quality index; learning a sound quality index model from the features to be used as the predictors; and completing the sound quality index model, wherein the correlation of the sound quality index model with the sound quality index evaluation is 0.9 or more.

The vehicle data may be a motor rpm and a vehicle speed, and may be obtained from driving evaluation under acceleration, deceleration, and regenerative braking, wherein the driving evaluation may be obtained from driving evaluation in a full load acceleration region, a low/medium load acceleration region, and a deceleration and regenerative braking region.

Prior to the jury test, the high-frequency whine noise component may be separated from the vehicle interior noise, and may be extracted by order analysis using an rpm of an electric vehicle part, especially a motor.

The sound quality index model may be learned by applying a regression analysis, wherein the sound quality index model may be a linear model, including any one or more of an electric vehicle whine noise quality index, a background noise quality index, and an overall noise quality index, more specifically a predictive regression analysis model in which levels of the separated high-frequency whine noise of an electric vehicle and the background noise are adjusted, re-combined, and then applied to the sound quality index model so that a new sound quality index for the changed noise source, rather than the noise source before the separation, may be evaluated.

According to the present disclosure, it is possible to improve the prediction accuracy for the sound quality index by separating the region of interest of the electric vehicle interior noise data into the noise source from the background noise source and the high-frequency whine noise source of the electric vehicle parts, performing the evaluation by NVH experts and general subjective evaluation (by the jury test), and then applying a highly correlated prediction model.

In addition, it is possible to predict the NVH feature according to various changes in circumstances by applying the technique of changing the level of a specific component from a separated noise source. That is, it is possible to previously predict the NVH feature through separation of noise sources and the correlation with NVH feature according to improvement of electric vehicle parts, which improves the efficiency of development work. In other words, it is possible to strategically evaluate the NVH feature for each noise source of electric vehicle parts noise and background noise, which contributes to performance comparison and establishment of development direction.

### BRIEF DESCRIPTION OF THE FIGURES

FIG. 1 is a flow chart of the development of an electric vehicle noise source separation and sound quality index technology.

FIG. 2 is a diagram illustrating an acquisition path of vehicle interior noise 100 and vehicle data 200.

FIG. 3 is a diagram illustrating a distribution map of EV driving regions and driving evaluation modes.

FIG. 4 is a diagram illustrating 13-mode conditions for performing a jury test.

FIG. 5A is an exemplary graph showing the correlation between jury test results and model results.

FIG. 5B shows the process of deriving an overall noise model by recombining separate noise sources from respective regression model for EV high-frequency whine noise and background noise.

FIG. 6 is a flowchart illustrating a process of analyzing a sound quality index signal for evaluating the marketability of an electric vehicle.

FIG. 7 is a diagram illustrating the sound quality index analysis process according to the type of collected data.

### DETAILED DESCRIPTION

The sound quality index prediction for high-frequency whine noise of an electric vehicle from which interior noise is separated according to the present disclosure will now be described in detail with reference to the accompanying drawings.

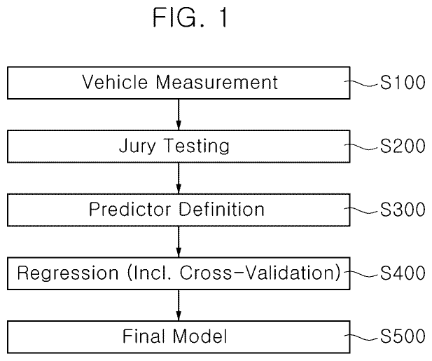

According to the present disclosure, a process provided in FIG. 1 is performed so that interior noise data, motor rpm data, and vehicle speed data are used to separate a high-frequency whine noise component and a background noise component, and a sound quality index prediction model, to which a sound quality index with 90% correlation with a subjective evaluation is applied, is obtained.

First, the first step S100 in FIG. 1 is to acquire noise data using a sensor in a vehicle for dataset required in the present disclosure. To acquire the noise data, interior noise data for each driving mode is measured for the subject company's and competitors' vehicles, and driving evaluation is performed.

From the acquired noise data, the high-frequency whine noise component of an electric vehicle parts, such as a motor, a reducer, etc. and the background noise are separated from each other. In this case, the high-frequency whine noise component may be extracted by order analysis using the rpm of rotating electric vehicle parts such as a motor, a reducer, etc.

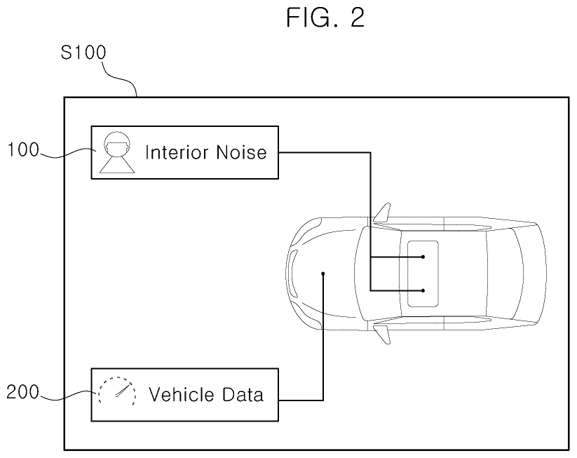

FIG. 2 is a conceptual diagram illustrating acquiring vehicle interior noise 100 data and vehicle data 200 in the first step S100 of FIG. 1. The vehicle interior noise 100 is acquired from driver's and passenger's seats, and the vehicle data 200 is an rpm of a motor and a vehicle speed. The vehicle interior noise is measured following a vehicle traveling along a predefined driving mode, which includes driving modes based on acceleration, deceleration, and regenerative braking. A dataset is prepared by the interior noise data measured from the driver's and passenger's seats, the vehicle speed, and the motor rpm.

The second step S200 of FIG. 1 is to classify the vehicle data for each driving mode and for each vehicle type, and perform a jury test to generate laboratory acoustic evaluation data. The jury test is a subjective evaluation of evaluators by age, with or without NVH expertise, gender, and region. The results of the jury test complete the dataset. The results of the jury test are used to evaluate the sound quality index for the high-frequency while noise component in which the background noise is separated from the vehicle interior noise data.

On the other hand, since it is not possible to evaluate all areas for performing the jury test, the jury test may be performed only for the representative evaluation mode of the sound quality index.

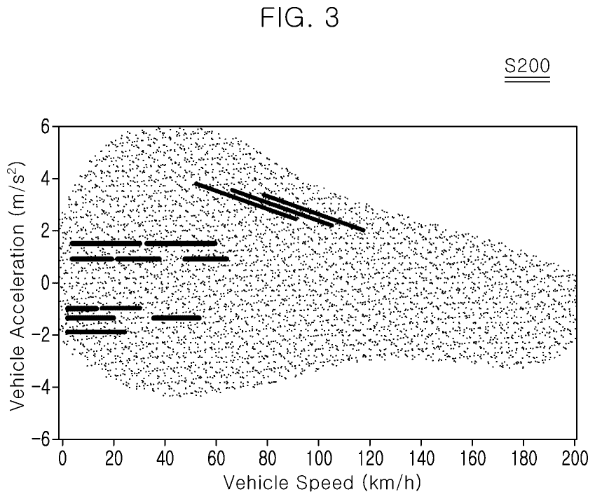

FIG. 3 illustrates representative evaluation modes used in the jury test of the second step S200 of FIG. 1. The representative evaluation modes include a total of 13 modes: 3 modes in the full-load acceleration region, 5 modes in the low/medium load acceleration region, and 5 modes in the deceleration/regenerative braking region, selected from the distribution diagram of EV driving regions. On the other hand, the proposed representative evaluation modes are exemplary, and new selections of critical driving region and sound quality index region may be made based on the different patterns for each driver for each country and for each area.

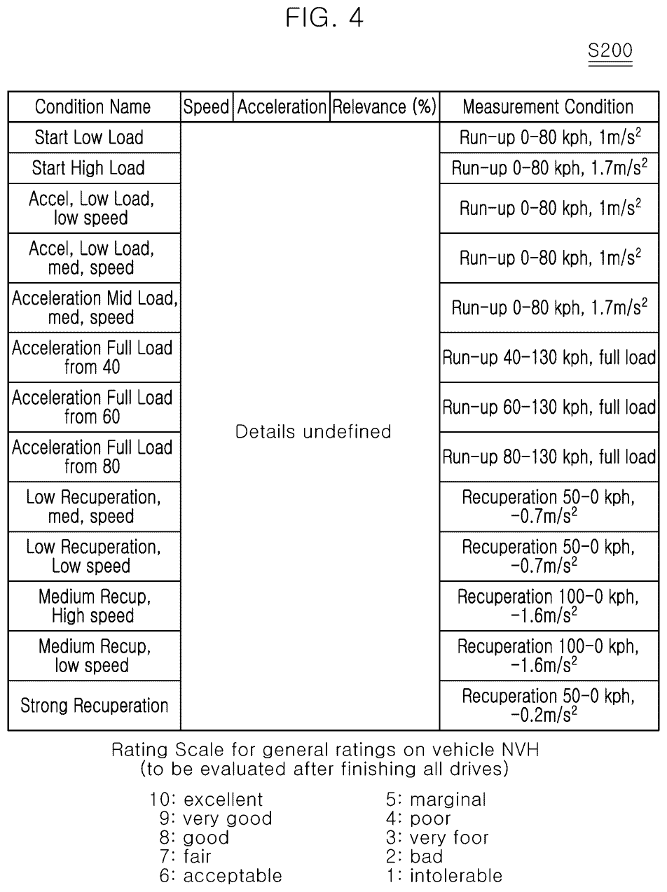

FIG. 4 illustrates 13 mode conditions for performing the jury test in the second step S200. In FIG. 4, columns 1 to 5 refer to condition names having 5 modes from low load start to load run-up of 0 to 80 kph and with low/medium load acceleration regions of 1 to 1.7 m/s², columns 6 to 8 refer to 3 modes in the full-load acceleration region, columns 9 to 13 refer to 5 modes in the deceleration and regenerative braking region, and the rating scale of the jury test is calculated after all driving modes are completed.

The evaluation results according to the jury test are expressed on a scale of 1 (intolerable) to 10 (excellent), and the speed, acceleration, and correlation % set for each jury test condition may be arbitrarily selected according to the applicable target vehicle type, and are not specifically disclosed in the present disclosure.

The third step S300 of FIG. 1 is to define predictors, which extract correlated features from the dataset established by the jury test results. The predictors may separately extract features for electric vehicle whine noise, background noise, and overall noise. It is also possible to develop a function of generating new EV interior sound by level change and re-combination of the separated noises. The combined dataset becomes an observation value for a regression analysis model.

The fourth step S400 in FIG. 1 is to learn a sound quality index model with high correlation (R²=0.9) with subjective evaluation results through training and validation. A sound quality index model with a correlation of 0.9 or more with the subjective evaluation results, the jury test evaluation results for high-frequency whine noise, background noise, and overall noise is learned. The sound quality index model of the present disclosure is learned by applying a regression analysis classification model.

The model developed through learning may be cross-validated to confirm the robustness.

The sound quality index model is developed into three models: electric vehicle whine noise sound quality index, background noise sound quality index, and overall noise sound quality index. In the third step S300 of FIG. 1, features for electric vehicle whine noise, background noise, and overall noise are extracted by applying predictors with high correlation with jury test results, and in the fourth step S400, a predictive regression analysis model, which is a mathematically linear model, is applied thereto. The predictive regression analysis model is represented by the multiple linear regression model shown in [Equation 1].

$$Metric Result = {\sum }_{k = 1}^{m} ( {x}_{k} \cdot {A}_{k} ) + {x}_{0} \qquad [ Equation 1 ]$$

where m is the number of acoustic analysis algorithms, x is a coefficient, and A is applied acoustic analysis algorithm results (e.g., tone to noise, relative approach, FFT. loudness, etc.).

[Equation 1] represents the sound quality evaluation index corresponding to the jury test results. The jury test results in the second step are represented on an Y-axis as 1 to 10.

[Equation 1] shows, on an X-axis, the results of multiplying the acoustic analysis algorithm results A applied to the model and the features extracted in the third step by the influence (x, weight) on the acoustic analysis algorithm results A and summing the product results. In other words, the product results of the acoustic analysis algorithm results applied to the modeling and the coefficient are summed until the number of acoustic analysis algorithms varies and reaches the number of acoustic analysis algorithms applied to the modeling are matched with the jury test evaluation results, and least mean squares (LMS) optimization in which the difference between the jury test result and the calculation result by [Equation 1] is minimized is applied so that the influence coefficient x is derived. In addition, the robustness of the model is secured to enable prediction accuracy with a correlation of 0.9 or higher through training and validation of the model. Here, xo is a constant value determined by input interior noise.

In addition, it is possible to model not only the respective noise quality evaluation indexes for the separate electric vehicle high-frequency whine noise and background noise, but also the overall noise quality evaluation index for the recombined high-frequency whine noise and background noise.

In the fifth step S500 of FIG. 1, a model capable of predicting observations according to the sound quality index model is finally completed, and the quantitative sound quality index analysis of an electric vehicle using interior noise data may be applied to a user interface tool from the model.

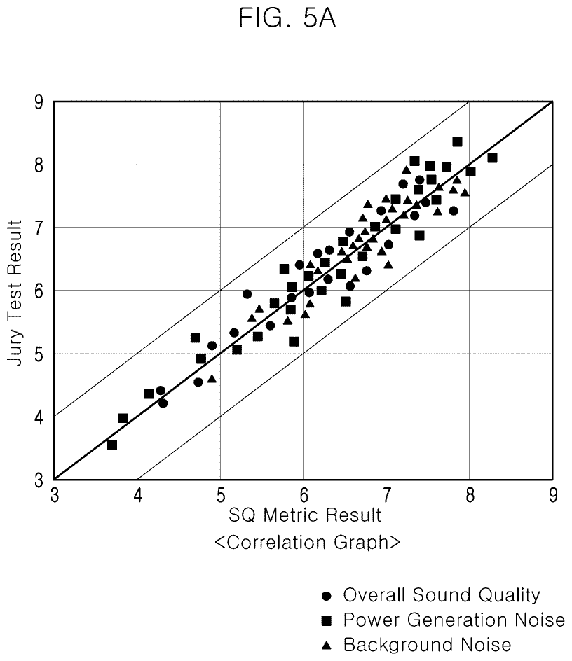

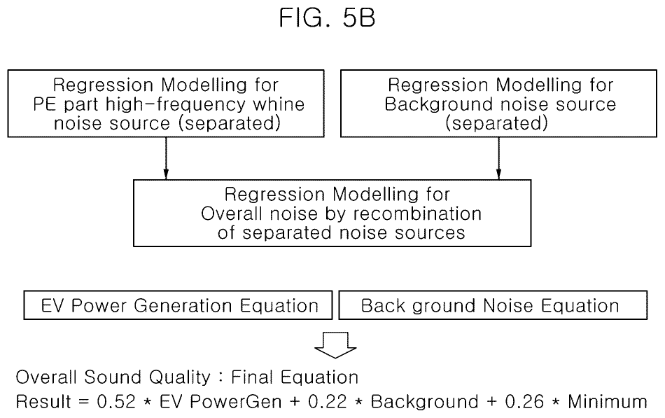

FIG. 5A is an exemplary graph showing the correlation between the jury test results and the model results, and FIG. 5B shows the process of deriving an overall noise model through the recombination of separated noise sources from respective regression models for electric vehicle high-frequency whine noise and background noise.

In FIG. 5B, the electric vehicle power generation equation and background noise equation are modeled respectively, and the overall sound quality equation is obtained from the respective models. Here, the result in FIG. 5 shows an example thereof. When there is a change in the level of high-frequency whine noise and background noise in the interior noise of an electric vehicle to be developed, the performance result of the interior noise may be predicted. In other words, when the current level is evaluated when developing an electric vehicle, if the level of high-frequency whine noise is improved by 3 dB, the predicted value of the improved sound quality index may be obtained.

For example, in the current sound quality index model with a score of 6 for whine noise, 7 for background noise, and 6 for overall noise, a 3 dB improvement in whine noise would result in a score of 7.5 for high-frequency whine noise, 7 for background noise, and 7 for overall noise. Through this prediction, it is possible to predict the amount of improvement in high-frequency whine noise and background noise in advance in order to match or exceed the interior noise level of competitors, thereby improving development efficiency and reducing development time and cost.

In [Equation 1], the coefficients of 0.52 and 0.22 are obtained by applying the results of two regression models for high-frequency whine noise and background noise, and the value of 0.26*minimum is a kind of correction bias value. That is, the correction bias value completes the regression model value such that the correlation between the jury results and the calculation results by [Equation 1] for the overall interior noise level is R²>0.9.

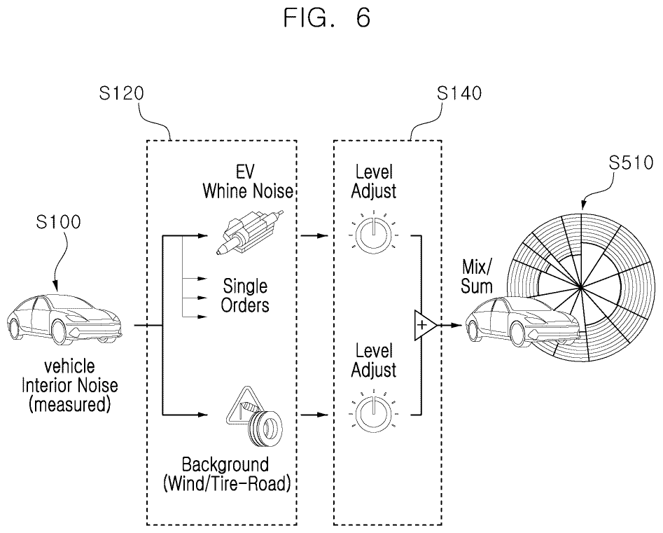

FIG. 6 is a flowchart illustrating the sound quality index signal analysis processing for evaluating the marketability of an electric vehicle. By adjusting the levels of the electric vehicle high-frequency whine noise and background noise, respectively, and combining them again, a changed noise source is obtained, instead of the noise sources before separation. For the changed noise source, it is possible to predict the sound quality index with a 90% correlation with the subjective evaluation results. Here, for the separated high-frequency whine noise of the electric vehicle, it is possible to increase/decrease the level of each order component obtained from the order analysis as a whole, or to increase/decrease the level of a specific order component only. In addition, the level may be increased/decreased with respect to the background noise.

In other words, it is shown that a new or modified noise source is generated (S510) by separating the measured vehicle interior noise (in S100) into the high-frequency whine noise of the electric vehicle and the background noise (in S120), and adjusting and combining the separated high-frequency whine noise and background noise levels (in S140), respectively. The combining refers to summing or partially mixing the adjusted levels.

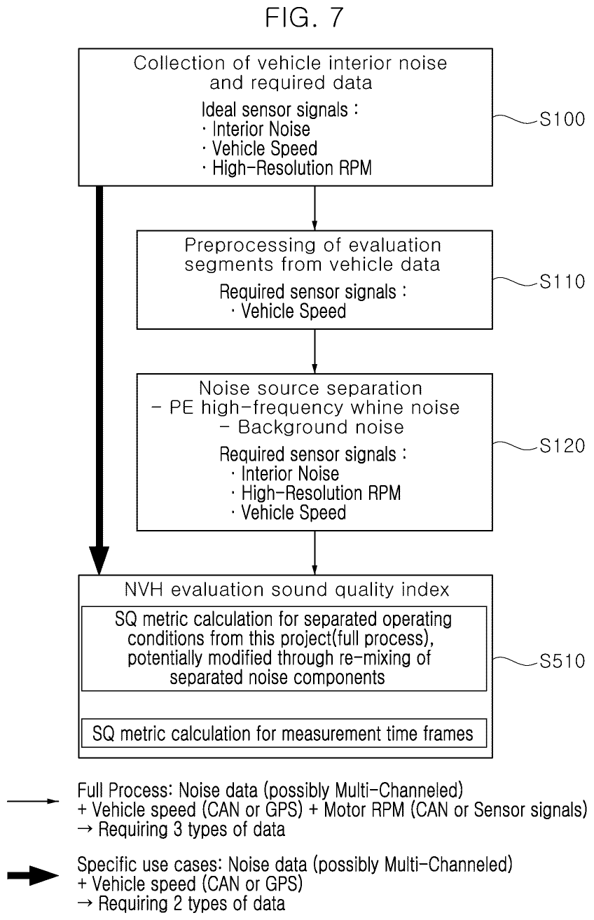

FIG. 7 illustrates a processor that applies and analyzes a sound quality index model trained through processes S100 to S500, depending on the type of data collected, for the purpose of evaluating the marketability of an electric vehicle.

S100 is a step of acquiring vehicle interior noise data and vehicle data (vehicle speed and motor speed). S110 is a step of preprocessing evaluation segments from the vehicle data, and preprocessing the evaluation segments according to the vehicle speed.

S120 is a step of separating the noise source into high-frequency whine noise of the electric vehicle and background noise for each evaluation section.

S510 is a step of comparing and evaluating the marketability of the electric vehicle with the NVH evaluation sound quality index calculated from the previously established sound quality index model by adjusting the levels of the separated high-frequency while noise of the electric vehicle and background noise, respectively.

In other words, by respectively adjusting and combining the levels of the high-frequency whine noise of the electric vehicle and the background noise, a new NVH evaluation sound quality index may be calculated from the previously established NVH evaluation sound quality index, from the jury test. Such a sequential entire process requires three types of data: noise data, which may be multi-channeled, vehicle speed from CAN or GPS signals, and motor speed from CAN or sensor signals.

On the other hand, for a specific use case, only two types of data are applied: the noise data, which may be multi-channeled, and the vehicle speed acquired from CAN or GPS signals. That is, from S100, where noise data and vehicle speed are acquired, the NVH evaluation sound quality index of S510 is directly calculated for the time frame from the sound quality index model by skipping the steps of S110 and S120. In other words, only the sound quality index analysis of the interior noise data may be performed, and the motor rpm for noise source separation is not acquired, so the noise source separation and noise source-specific level control functions are excluded.

In other words, it is possible to generate a new electric vehicle interior sound through level change and combination (or re-combination) of the separated noise sources. In other words, using the final model (S500) created in FIG. 1, it is possible to generate the new noise in FIGS. 5 and 6, which is a useful application example by applying the level adjustment to the previously established final model. From the measured vehicle interior noise, it is possible to predict the NVH performance evaluation according to the change in high-frequency whine noise, the NVH performance evaluation according to the change in background noise, and the NVH performance evaluation for the recombined interior noise, and it is possible to improve business efficiency by using the prediction results to predict the effect before and after the actual H/W improvement.

1. A method of predicting a sound quality index of an electric vehicle, the method comprising:
acquiring vehicle interior noise and vehicle data of the electric vehicle;
evaluating, by a jury test, the sound quality index for a high-frequency whine noise component of the vehicle interior noise;
extracting features to be used as predictors for modeling the sound quality index;
learning a sound quality index model from the features to be used as predictors; and
completing the sound quality index model,
wherein a correlation of the sound quality index model with a sound quality index evaluation is 0.9 or more.

2. The method of claim 1, wherein the vehicle data is motor rpm and vehicle speed.

3. The method of claim 2, wherein the vehicle data is obtained from a driving evaluation based on acceleration, deceleration, and regenerative braking.

4. The method of claim 3, wherein the driving evaluation is obtained from driving evaluation in a full load acceleration region, a low/medium load acceleration region, and a deceleration and regenerative braking region.

5. The method of claim 4, wherein the driving evaluation has a total of 13 modes, including 3 modes in the full load acceleration region, 5 modes in the low/medium load acceleration region, and 5 modes in the deceleration and regenerative braking region.

6. The method of claim 1, wherein prior to the jury test, the high-frequency whine noise component is separated from the vehicle interior noise.

7. The method of claim 6, wherein the high-frequency whine noise component is extracted through an order analysis using an rpm of parts of the electric vehicle.

8. The method of claim 1, wherein the sound quality index model is learned by applying regression analysis.

9. The method of claim 8, wherein the sound quality index model is a linear model of at least one of an electric vehicle whine noise quality index, a background noise quality index, and an overall noise quality index, and is a predictive regression analysis model.

10. The method of claim 6, wherein when levels of a separated electric vehicle high-frequency whine noise and background noise are applied to the sound quality index model after the levels are respectively adjusted and recombined, the sound quality index evaluation is performed for a changed noise source rather than a noise source before the separation.
